(19) United States
(12) Patent Application Publication
(10) Pub. No.: US 2015/0230436 A1
(43) Pub. Date: Aug. 20, 2015

(54) MAGNETIZED MAT FOR AN AQUARIUM

(71) Applicant: Elive LLC, New Berlin, WI (US)

(72) Inventors: Thomas Lutz, Cedar Rapids, IA (US); Daniel A. Engmark, New Berlin, WI (US); Matthew Allen, Waterford, WI (US); Ernie Katris, New Berlin, WI (US)

(21) Appl. No.: 14/620,529

(22) Filed: Feb. 12, 2015

Related U.S. Application Data
(60) Provisional application No. 61/940,024, filed on Feb. 14, 2014.

(51) Int. Cl. A01K 63/00; H01F 7/02

(52) U.S. Cl. CPC A01K 63/006; H01F 7/0215

(57) ABSTRACT

An aquarium includes a base and at least one side wall coupled to the base that together define an interior of the aquarium. The aquarium also includes a non-magnetic mat sized to fit within the aquarium such that a bottom surface of the mat engages the base and a top surface of the mat is exposed to the interior. The aquarium also includes at least one magnetic element coupled to the mat, and a removable décor feature that is magnetically attracted toward the at least one magnetic element.

### CROSS-REFERENCE TO RELATED APPLICATIONS

This application claims priority to U.S. Provisional Application No. 61/940,024, filed Feb. 14, 2014, the entire contents of which are incorporated herein by reference.

### BACKGROUND

Aquariums often include inanimate features that make up the décor of the aquarium. For example, plants (real or artificial), rocks, coral (real or simulated), or other objects are often placed in an aquarium to enhance the look. Some of these features can be difficult to place in the desired position. For example, artificial plants often float making it difficult to anchor them on the bottom of the aquarium.

### SUMMARY

In accordance with one construction, an aquarium includes a base and at least one side wall coupled to the base that together define an interior of the aquarium. The aquarium also includes a non-magnetic mat sized to fit within the aquarium such that a bottom surface of the mat engages the base and a top surface of the mat is exposed to the interior. The aquarium also includes at least one magnetic element coupled to the mat, and a removable décor feature that is magnetically attracted toward the at least one magnetic element.

In accordance with another construction, an aquarium includes a base and at least one side wall coupled to the base that together define an interior of the aquarium. The aquarium also includes a flexible, magnetic mat sized to fit within the aquarium such that a bottom surface of the flexible, magnetic mat engages the base and a top surface of the flexible, magnetic mat is exposed to the interior, wherein the flexible, magnetic mat includes at least one magnetic element selected from a group consisting of a plurality of magnetic wires, a plurality of magnetic strips, a magnetic sheet, a plurality of magnetic particles, and an electrically powered wire.

Other aspects of the invention will become apparent by consideration of the detailed description and accompanying drawings.

### BRIEF DESCRIPTION OF THE DRAWINGS

FIG. 1 is a perspective view of a magnetic mat embodying an aspect of the invention;

FIG. 2 is a perspective view of the magnetic mat of FIG. 1 illustrating a magnetic element;

FIG. 3 is a perspective view of the magnetic mat of FIG. 1 illustrating another magnetic element;

FIG. 4 is a perspective view of the magnetic mat of FIG. 1 illustrating another magnetic element;

FIG. 5 is a perspective view of the magnetic mat of FIG. 1 illustrating another magnetic element;

FIG. 6 is a perspective view of several décor features for use with the mat of FIG. 1;

FIG. 7 is a perspective view of the décor features of FIG. 6 placed on the mat of FIG. 1; and

FIG. 8 is a perspective view of a mat positioned within an aquarium and including a wireless power transfer arrangement.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

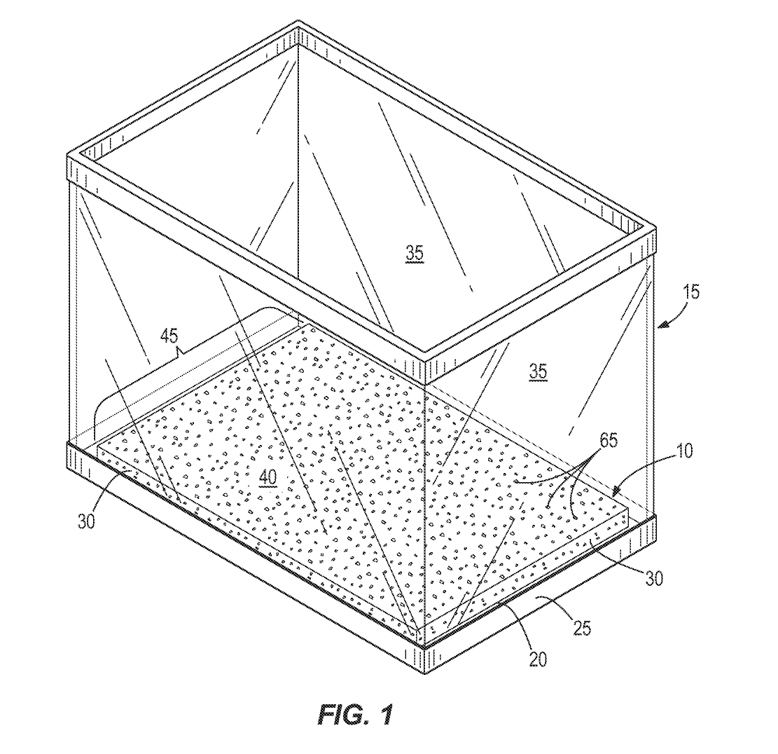

FIG. 1 illustrates a mat 10 or substrate that is suitable for placement in the bottom of an aquarium 15. The illustrated mat 10 is rectangular and is sized to fit a typical rectangular aquarium 15. Of course other sizes and shapes could be made to accommodate virtually any size or shape of aquarium 15. In addition, while the present description describes the mat 10 as being used in an aquarium 15, it could be applied in many other applications in addition to the aquarium 15.

With continued reference to FIG. 1, the mat 10 includes a bottom surface 20 that is placed against a base 25 of the aquarium 15, side surfaces 30 that preferably abut the side walls 35 of the aquarium 15, and a top surface 40 that is exposed to the interior of the aquarium 15. In preferred arrangements the top surface 40 is colored to match the desired environment. For example, a sandy or tan color could be employed and a sand texture could be applied to make the top surface 40 look like the sandy bottom of a body of water. Of course, other colors or textures could be employed to match virtually any desired environment.

The mat 10 is preferably manufactured from a foam or other plastic material that allows the mat 10 to be flexible. The flexibility should be sufficient to allow the mat 10 to be rolled for shipping or storage (e.g., able to be rolled at least 360 degrees about an axis) as well as to allow the mat 10 to be positioned on and conform to a base 25 that is not planar. In addition, the material selected should be suitable for use in a moist or a submerged environment. If the material selected is buoyant, features are provided to affix the mat 10 to the bottom or base 25 of the aquarium 15. For example, double sided tape, adhesives, VELCRO, fasteners, hooks, or the like could be employed to assure that the mat 10 does not float to the surface of the aquarium 15 when water is added.

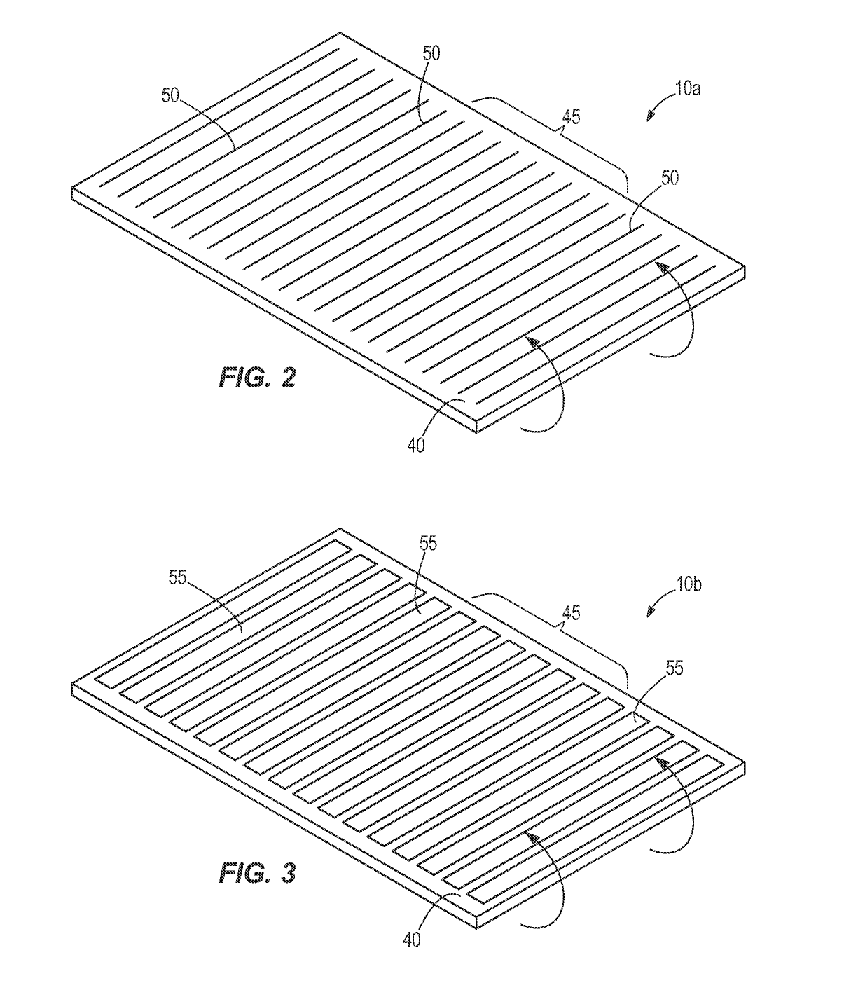

The mat 10a also includes a magnetic element 45 that is attached to, embedded within, or formed as part of the mat 10a. FIG. 2 illustrates one possible magnetic element 45 that includes a plurality of magnetic wires 50. In the illustrated construction, the magnetic wires 50 extend from one side of the mat 10a to the opposite side of the mat 10a and are spaced apart from one another in a direction normal to their direction of extension to largely fill the space defined by the top surface 40 of the mat 10a. The spacing of the wires 50 allows the mat 10a to be rolled up as desired without damaging the wires 50 or the mat 10a. The wires 50 are formed from a naturally magnetic material or include a magnetized ferromagnetic material such that no electricity is required to produce a magnetic field. In preferred constructions, the wires 50 are embedded or formed within the foam material that makes up the mat 10a. However, in preferred constructions, the wires 50 are placed as close as possible to, or on the top surface 40 to enhance the strength of the magnetic field at the top surface 40.

FIG. 3 illustrates a mat 10b similar to that shown in FIG. 2 including a magnetic element 45 formed from strips 55 of magnetic material arranged in a pattern similar to that of the wires 50 of FIG. 2. As with the construction of FIG. 2, the strips 55 are arranged to assure the desired level of flexibility without damaging the strips 55 or the mat 10b. The strips 55 are made from a naturally magnetic material or a magnetized ferromagnetic material and are placed as close as possible to, or on the top surface 40 to enhance the strength of the magnetic field at the top surface 40.

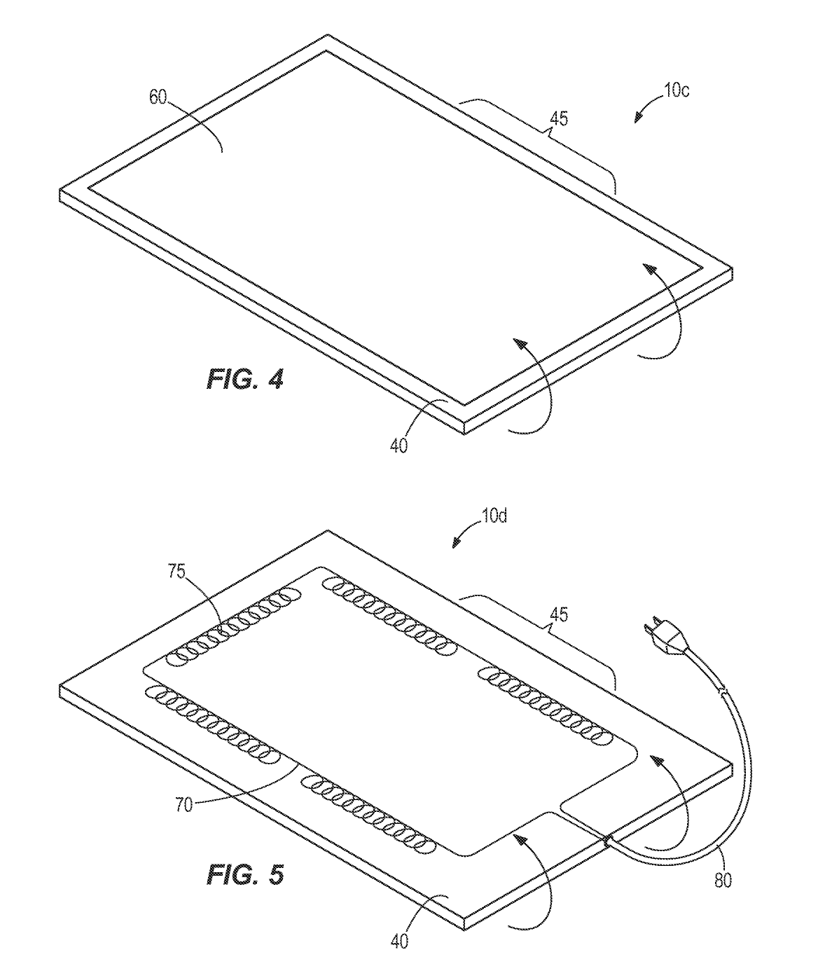

FIG. 4 illustrates yet another construction of a mat 10c in which a magnetic sheet 60 is embedded within or placed on the top surface 40 of the mat 10c. The magnetic sheet 60 is such that the mat 10c is still flexible enough to be rolled up but durable enough to not damage the magnetic sheet 60 or the mat 10c. In preferred constructions, the sheet 60 is placed as close as possible to, or on the top surface 40 to enhance the strength of the magnetic field at the top surface 40.

FIG. 1 illustrates yet another arrangement of the magnetic element 45 in the mat 10. The mat 10 of FIG. 1 is formed from a foam material that contains or is doped with small magnetic particles 65 that are dispersed throughout the mat during formation. In preferred constructions, naturally magnetic particles 65 or magnetized ferromagnetic particles 65 are employed. When the mat 10 is formed, a magnetic field is applied to align the particles 65 to enhance the magnetic field produced by the mat 10. The particles 65 are sized, and the density of the particles 65 is selected to assure that the mat 10 remains flexible enough to roll up for storage and shipping.

FIG. 5 illustrates another arrangement of a mat 10d which includes a magnetic element 45 that is electrically-powered. In preferred constructions, the magnetic element 45 includes a magnet wire 70 arranged in one or more coils 75 to produce a magnetic field. The wire 70 or coils 75 are embedded within or formed as part of the mat 10d and preferably disposed as near to the top surface 45 as possible. The wire 70 or coils 75 are arranged to assure that the mat 10d remains flexible and is able to be rolled up for storage or shipping. As illustrated in FIG. 5, a power cord 80 is provided to direct power from an electrical source such as a wall outlet to the wire 70 or coils 75 within the mat 10d.

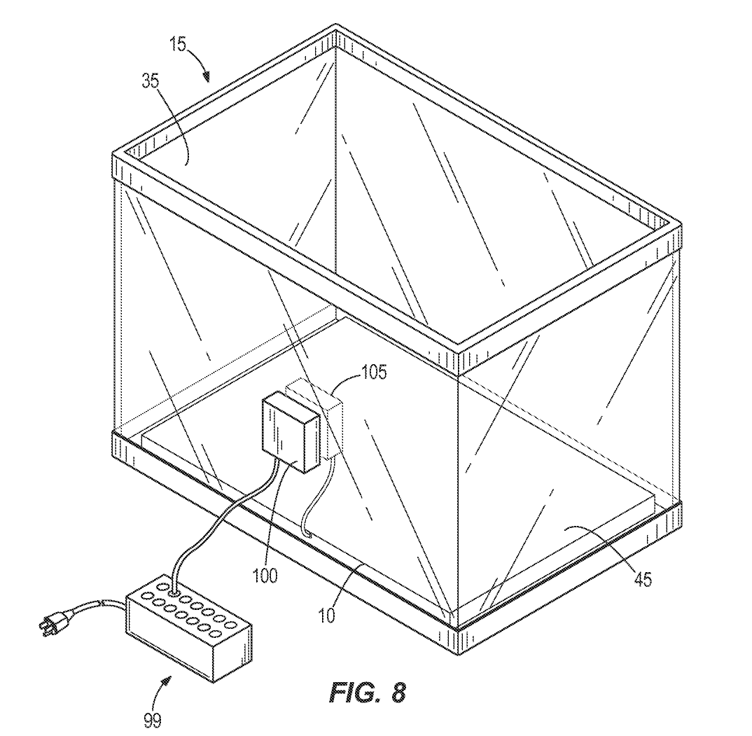

In another construction illustrated in FIG. 8, a wireless power supply 99 is used to direct electrical power from outside of the aquarium 15 to the mat 10 inside the aquarium 15. In this construction an exterior inductor 100 is positioned adjacent an interior inductor 105 that is part of the mat 10 or electrically connected to the mat 10. The exterior inductor 100 produces a magnetic field in response to the flow of electrical power therethrough. The interior inductor 105 is positioned within the magnetic field of the exterior inductor 100 and produces a current in response to that magnetic field. The current is used to induce the magnetic field in the mat 10.

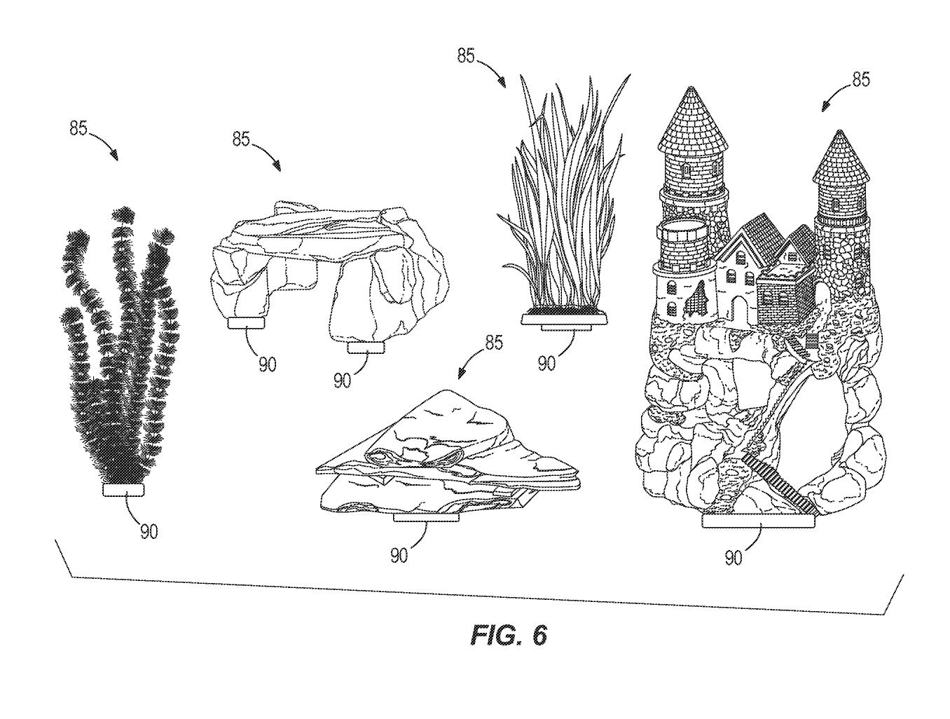

FIG. 6 illustrates several different décor features 85 that are suitable for use with the magnetic mat 10 of FIGS. 1-5. The features 85 illustrated include rocks, plants, and a castle but should not be limited to these items. For example, other décor features 85 could include corals, basking platforms, pots for live plants, etc. As one of ordinary skill will realize virtually any desired feature 85 could be used with the invention described herein.

Each of the features 85 includes a base 90 that is used to attach the feature 85 to the mat 10. The feature 85 includes a base 90 that preferably includes a magnet (natural or electrical) or a ferromagnetic portion that magnetically engages the mat 10 when placed in proximity. The base 90 should be covered with a thin plastic coating or other cover that inhibits contact between the base 90 and the water to inhibit unwanted corrosion while still allowing for the magnetic connection between the base 90 and the mat 10.

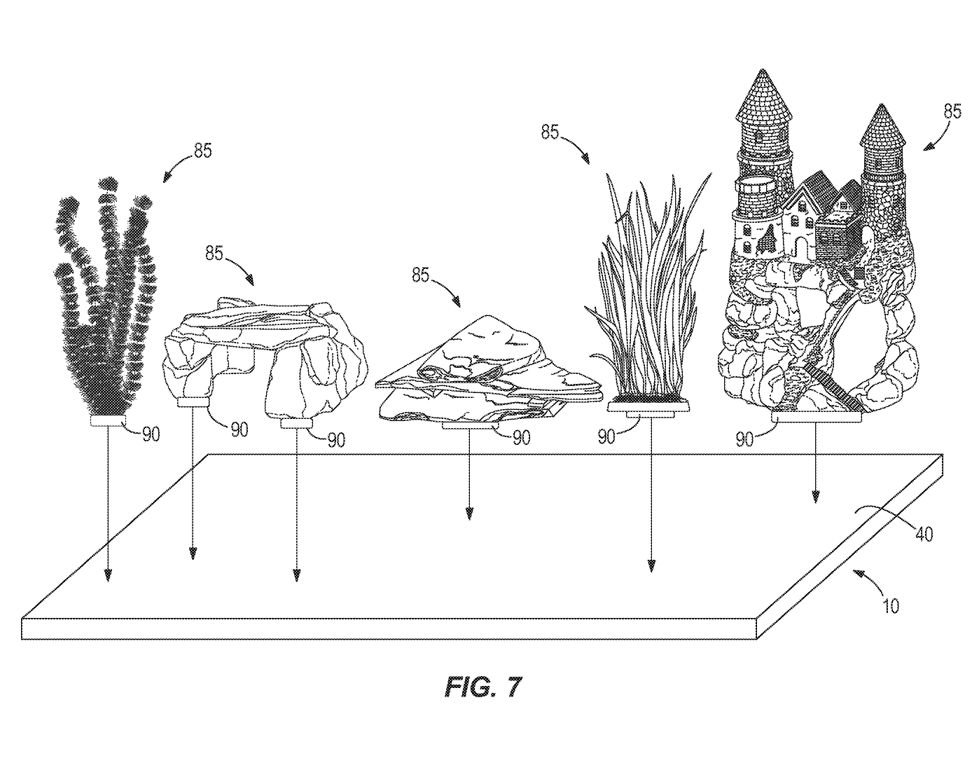

As illustrated in FIG. 7, the features 85 can be positioned anywhere on the mat 10 that a user desires. The magnetic field of the mat 10 cooperates with the base 90 of the individual features 85 to attach the features 85 to the mat 10 and hold them in the desired position.

Although the invention has been described in detail with reference to certain preferred embodiments, variations and modifications exist within the scope and spirit of one or more independent aspects of the invention as described.

1. An aquarium comprising:
a base and at least one side wall coupled to the base that together define an interior of the aquarium;
a non-magnetic mat sized to fit within the aquarium such that a bottom surface of the mat engages the base and a top surface of the mat is exposed to the interior;
at least one magnetic element coupled to the mat; and
a removable décor feature that is magnetically attracted toward the at least one magnetic element.

2. The aquarium of claim 1, wherein the mat is sized to completely cover the base within the interior of the aquarium.

3. The aquarium of claim 1, wherein the at least one magnetic element includes a plurality of magnetic wires that extend in a first direction from one side of the mat to an opposite side of the mat and are spaced apart from one another in a second direction normal to the first direction.

4. The aquarium of claim 3, wherein the magnetic wires are formed from a material selected from a group consisting of naturally magnetic materials and magnetized ferromagnetic materials.

5. The aquarium of claim 3, wherein the mat is formed from foam material, and the magnetic wires are embedded within the foam material.

6. The aquarium of claim 3, wherein the magnetic wires are disposed on the top surface of the mat.

7. The aquarium of claim 1, wherein the at least one magnetic element includes a plurality of magnetic strips that extend in a first direction from one side of the mat to an opposite side of the mat and are spaced apart from one another in a second direction normal to the first direction.

8. The aquarium of claim 1, wherein the at least one magnetic element includes a magnetic sheet.

9. The aquarium of claim 1, wherein the at least one magnetic element includes a plurality of magnetic particles that are dispersed throughout the mat.

10. The aquarium of claim 1, wherein the at least one magnetic element includes an electrically powered element.

11. The aquarium of claim 10, wherein the electrically powered element includes at least one coil embedded within and surrounded by a material of the mat, and wherein the electrically powered wire is coupled to a power cord.

12. The aquarium of claim 1, further comprising an exterior inductor disposed on an outside of the at least one side wall, and an interior inductor disposed within the interior of the aquarium, wherein the interior inductor is coupled to the mat.

13. The aquarium of claim 1, wherein the removable décor feature includes a base that includes a magnet.

14. The aquarium of claim 1, wherein the removable décor feature is selected from a group consisting of a rock, a plant, a castle, a coral, a basking platform, and a pot for a live plant.

15. An aquarium comprising:
a base and at least one side wall coupled to the base that together define an interior of the aquarium; and
a flexible, magnetic mat sized to fit within the aquarium such that a bottom surface of the flexible, magnetic mat engages the base and a top surface of the flexible, magnetic mat is exposed to the interior, wherein the flexible, magnetic mat includes at least one magnetic element selected from a group consisting of a plurality of magnetic wires, a plurality of magnetic strips, a magnetic sheet, a plurality of magnetic particles, and an electrically powered wire.

16. The aquarium of claim 15, further comprising an exterior inductor disposed on an outside of the at least one side wall, and an interior inductor disposed within the interior of the aquarium, wherein the interior inductor is coupled to the flexible, magnetic mat and is operable to deliver an electric current to the at least one magnetic element.

17. The aquarium of claim 15, wherein the at least one magnetic element is disposed on the top surface of the flexible, magnetic mat.

18. The aquarium of claim 15, wherein the at least one magnetic element is embedded within a material of the flexible, magnetic mat.

19. The aquarium of claim 15, further comprising a removable décor feature selected from a group consisting of a rock, a plant, a castle, a coral, a basking platform, and a pot for a live plant, wherein the removable décor feature includes a base having a magnet that is attracted to the flexible, magnetic mat.

20. The aquarium of claim 15, wherein the mat is sized to completely cover the base within the interior of the aquarium.
